(19) United States
(12) Patent Application Publication
(10) Pub. No.: US 2003/0134111 A1
(43) Pub. Date: Jul. 17, 2003

(54) Adhesive tape for reel changeover and use thereof

(76) Inventors: Bernhard Gebbeken, Hamburg (DE); Christoph Nagel, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/226,761

(22) Filed: Aug. 23, 2002

(30) Foreign Application Priority Data
Jan. 15, 2002 (DE) 102 01 404.3

(51) Int. Cl. A47G 1/17; B32B 7/12

(52) U.S. Cl. 428/343; 428/354; 248/205.3

(57) ABSTRACT

For static manual reel changeover of flat web material wound up into reels a self-adhesive tape is used which is provided with a main carrier (2), a self-adhesive composition (3) on the face, and at least one adhesive splittable system on the reverse, the self-adhesive composition (3) having a shear strength of at least 1000 minutes on coating basepaper and at least 2000 minutes on gravure paper, measured in each case at 23° C. and 55% relative humidity under a load of 1 kg.

### Description

The invention relates to an adhesive tape for reel changeover of flat web material wound up into reels, which is equipped with a main carrier, a self-adhesive composition on the face, and at least one adhesive splittable system on the reverse.

The invention further relates to the use of an adhesive tape of this kind. For the continuous processing of flat web material wound up into reels, in papermaking plants or the like, for example, a variety of processes are employed.

For large-scale production plants, which operate with virtually no down time, reel changeover is carried out on the fly. In this system the paper supply is detected on a reel in operation. As soon as the paper supply comes to an end, a new reel is driven, so that the web start of the new reel is at the same speed as the web end of the old reel. The web ends are bonded to one another by means of adhesive tapes, and the web end of the old reel and web start of the new reel can both be adhered to the face of the adhesive tape. In that case it is known to provide the reverse with a splittable, double-sided adhesive tape, in order to fasten the start of the new reel to the underlying winding, in order to prevent unintended uncoiling of the web and, following the production of the adhesive bond, to ensure that the start of the reel is released under defined detachment conditions.

In the case of less complex equipment, such as rewinders, reel cutters and cross cutters, for example, manual reel changes are carried out statically. In this case, for example, two drums of paper can be joined to one another in order to be able, for example, to cut reels of a desired length. In other cases, one drum is rewound and a new start is adhered, in order to remove faulty sections of paper. In the case of static, manual reel changeover, the paper drum is stopped, the end of one drum is bonded to the start of the other, and then web travel is recommenced. This is done using double-sided adhesive tapes, called splicing tapes, or single-sided adhesive tapes. The adhesive tapes used for this purpose, in addition to a paper carrier, have a water-soluble self-adhesive composition on one or both sides. These adhesive tapes are bonded manually to join the end of one reel of paper to the start of the new reel.

When using the double-sided adhesive tapes, the adhesive tape with the adhesive lying exposed is bonded flush to the topmost paper ply of one web, the release paper is removed, and then the paper ply of the other drum is bonded to the adhesive which is now exposed. Overhanging paper residues are removed by cutting or tearing.

When using single-sided adhesive tapes, the adhesive tape is bonded halfway under the topmost paper ply of one drum and the other end of the reel that is to be bonded is fastened to the adhesive now lying exposed. These adhesive tapes advantageously have a centrally slitted release paper, so that in each case the only adhesive exposed is that on which the paper is bonded. This splicing technique is used especially in the case of splices which remain in the reel of paper for a very long time. Because of their low thickness, the risk of pressure points and instances of adhesive squeezeout in the paper reel is particularly low.

The adhesive tapes used for static manual reel changeover are required to comprise particularly shear-resistant adhesives, since during startup of the reels there may be considerable tensile stresses, owing for example to non-uniform startup operations and to high winding tensions that may be desired. As a result of these tensile stresses, adhesive tapes not coated with adhesives possessing high shear strength may fail.

For the manual application of the known adhesive tapes, operatives are needed. Moreover, it is generally necessary to use mechanical aids which keep the paper web from the reel, in order to prevent unwanted sticking, or which ensure even cutting and bonding. In general it is necessary to employ two workers in order to ensure the job is performed properly.

The problem on which the invention is based is to simplify static manual reel changeover.

In order to solve this problem, in an adhesive tape of the type mentioned at the outset, in accordance with the invention, for the purpose of absorbing high runup forces in a static manual reel changeover, the self-adhesive composition has a shear strength of at least 1000 minutes on coating basepaper and at least 2000 minutes on gravure paper, measured in each case at 23° C. and 55% relative humidity under a load of 1 kg.

The abovementioned problem is further solved by the use of an adhesive tape, formed with a main carrier, a self-adhesive composition on the face, and at least one splittable system on the reverse, for carrying out static manual reel changeover of flat web material wound up into reels, following application of a self-adhesive composition which has a shear strength of at least 1000 minutes on coating basepaper and at least 2000 minutes on gravure paper, measured in each case at 23° C. and 55% relative humidity under a load of 1 kg.

The adhesive tape of the invention is similar to the adhesive tape intended for flying reel changeover (flying splice) but in accordance with the invention is provided with a self-adhesive composition which is able to absorb the high tensile forces accompanying static manual reel changeover. Accordingly, an adhesive tape of this kind is used in accordance with the invention for a static manual reel changeover.

In this context it is appropriate if equal areas of the self-adhesive composition are present for the end of the old reel and the start of the new reel; in other words, if the adhesive tape is of symmetrical design in the transport direction in terms of the old reel and the new reel. Where the self-adhesive composition is provided with a covering which is itself provided with a perforation or slit transverse to the moving direction (i.e., in the lengthwise direction of the adhesive tape), the perforation or slit is appropriately located in the center. Arranged symmetrically with respect to this center, in addition, is the splittable adhesive system, of which there is at least one.

In one very preferred embodiment of the invention, the self-adhesive composition used is an acrylic pressure sensitive adhesive (PSA). It is possible with advantage to use both water-soluble and water-insoluble acrylates.

It is also possible, moreover, to use natural rubber and synthetic rubber compositions and also dispersions of the compounds described above. Reference may be made to the fact that it is possible in principle to use any basic types of PSA which meet the inventive criteria.

The shear strength is measured as follows:

To measure the shear strength of adhesives, they are coated onto a standard carrier (polyester film; thickness: 25 μm). Advantageously, the same application rate of 25 g/m² is chosen in every case.

After drying and, where appropriate, crosslinking of the adhesive, a strip 13 mm wide and at least 20 mm long is cut out and is stuck onto a defined paper (e.g., gravure paper, such as Neopress T 54, 54 g/m², or coating basepaper, e.g., Mediaprint, 135 g/m²). The bond area is 13 mm×20 mm. In order to ensure a constant applied pressure during bonding, the test specimen is overrolled twice slowly using a roller (weight: 2 kg). The test specimen thus produced is loaded with a weight of 1 kg parallel to the plane of the bond, and the time for which the adhesive strip remains on the paper is recorded. In order better to differentiate the individual adhesives, the test is conducted correspondingly at further temperatures (e.g., 40° C. and 70° C.).

In order to ensure error-free functioning, the adhesive must withstand a weight of 1 kg for more than 1000 minutes on coating basepaper and for more than 2000 minutes on gravure paper at 23° C. and 55% relative humidity.

As the self-adhesive composition it is possible, for example, to use acrylic self-adhesive compositions of the following makeup:

from 40 to 90% by weight acrylic acid, 60 to 10% butyl acrylate, or

from 40 to 90% by weight acrylic acid, from 30 to 5% by weight butyl acrylate,

from 30 to 5% by weight ethylhexyl acrylate plasticizer addition: ethoxylated alkylamines, preferably C16 to C18, more preferably containing from 15 to 25 ethoxy units.

The blending of plasticizer with polymer amounts to between 55 to 75% by weight plasticizer and 25 to 45% by weight polymer.

Polymerization takes place free-radically in polar solvents using ethanol as regulator. Partial crosslinking takes place with aluminum chelate (from 0.3 to 1.2% by weight, based on the total amount).

The self-adhesive composition is applied at an application rate of preferably from 20 to 60 g/m², very preferably between 25 and 50 g/m².

The splittable system advantageously has a much lower splitting resistance than a paper carrier which must absorb tensile forces. The splittable system or systems are based preferably on sized highly compacted paper, on a composite of paper and film or on a composite of two films, it being possible for the composite to consist of films and/or papers joined in a defined pointwise and/or linear way. For these purposes, the following papers, paper composite systems or films are particularly suitable examples:

readily splittable paper systems

duplex papers (papers laminated to one another in a defined way; the splitting process is extremely homogeneous with no peaks in tension as a result of inhomogeneous compression, for example. These papers are used for producing wall coverings and filters.)

papers glued to one another in a defined way and highly compacted (papers possessing high splitting resistance).

The glueing can be carried out, for example, with starch, derivatives containing starch, methylcellulose-based wallpaper pastes (tesa® paste, tesa AG, Hamburg; Methylan®, Henkel KgaA, Dusseldorf) or else those based on polyvinyl alcohol derivatives.

Such systems are described, for example, in EP 0 757 657 A1.

splittable systems in which the splitting forces are defined by the size of the bonding points; such systems are described, for example, in DE 198 41 609 A1.

coextruded films.

The splittable system or systems are advantageously the same width as the main carrier. In one other advantageous embodiment, however, it is of advantage if the main carrier is wider than the spliftable systems. It is also advantageous if the main carrier protrudes beyond the splittable systems in the region of the leading edge (long edge 14) by up to 75 mm.

In the case of particular embodiments, the overhang may be smaller, for example, from 0.5 to 15 mm, preferably from 1 to 7 mm, very preferably from 1.5 to 3.5 mm.

Where two or more splittable systems are applied to the adhesive tape, the distance between the splittable systems is advantageously from 3 to 50 mm. It is preferred to choose distances from 25 to 45 mm, very particularly distances from 30 to 40 mm.

Preference is given to using as the main carrier a paper or film backing of high tensile strength. Examples of such carrier materials include papers with slight crêping, machine-finished basepapers, one-side coated glazed basepapers, two-sides coated, compacted, printable decor papers, high-gloss chemical fiber kraft papers coated twice on one side, without wishing to be restricted unnecessarily in the choice of carrier materials as a result of providing these examples.

Where there are two or more spliftable systems on the adhesive tape, they may be composed of the same material and may therefore have identical splitting forces, although it may also be of advantage to provide spliftable systems made of different material, so that they possess different splitting forces.

It is particularly advantageous if the splitting resistance of the splitting system is from 5 to 70 cN/cm, in particular from 12 to 60 cN/cm. As regards measuring the splitting resistance, refer to DE 199 02 179 A1.

In the splicing process, an adhesive tape is bonded in a straight line to a reel of paper, with the splitting system beneath the topmost web, a section of the centrally slitted release paper is removed, and the topmost paper ply is bonded to the adhesive, which now lies exposed, and the projecting paper is torn off to leave part of the adhesive tape free, while the underside of the adhesive tape is bonded to the underlying web and so secures the topmost web. To start with, only one section of the covering that there may be on the self-adhesive composition has been removed, so that the part of the self-adhesive composition needed for the splicing process is still lined with the covering and the reel in this state has no free adhering surface. Then, for final preparation of the splicing process, any remaining covering is removed, the end of the paper that is still to be bonded is adhered to the adhesive, which is now exposed, any projecting paper is removed by tearing, the reel of paper is accelerated again and the splitting carrier splits and, with its remainders, provides a nonadhering covering over the two self-adhesive compositions which were coated on it. In the course of the subsequent process, after splicing has taken place, the bond site together with the webs adhesively joined in this way passes through a rewinder, roll cutter or, for example, cross cutter.

After the paper web has been accelerated, therefore, the splittable system of the adhesive tape splits, so that the topmost paper ply of the new roll is released and there are no longer any tacky residues open.

In order to withstand the high web tensions in the machine and pressures in the finished reel, it is preferred to use an inventive adhesive tape, i.e., one which possesses an adhesive of particularly high shear strength, for joining the paper webs and on the splitting system.

The splicing process can be carried out advantageously by bonding the adhesive tape in a straight line at right angles or at an acute angle transversely to the running web.

The intention of the text below is to describe the invention in more detail with reference to an example, without wishing to subject the invention to any unnecessary restriction as a result of so doing, however. In the drawings,

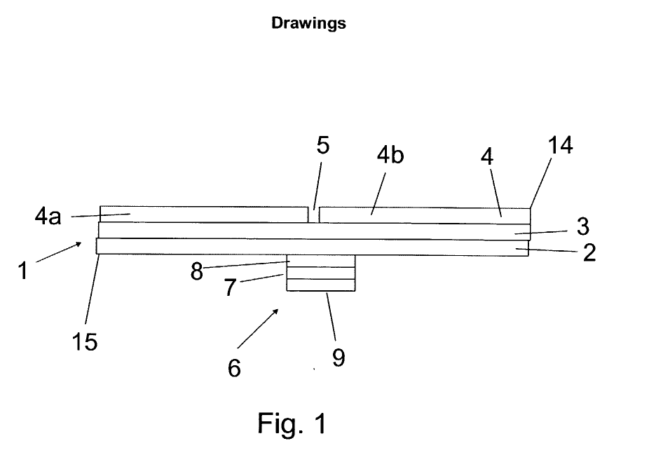

FIG. 1 shows a diagrammatic side elevation of an adhesive tape of the invention

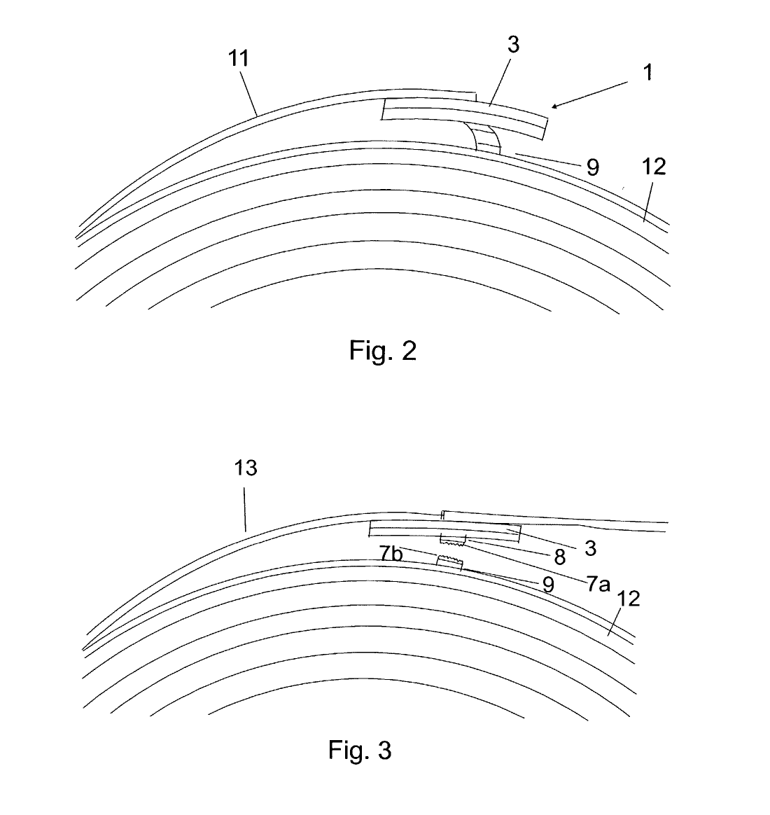

FIG. 2 shows a diagrammatic side elevation of an adhesive tape as in FIG. 1, adhered to a reel of paper and ready for manual static reel changeover

FIG. 3 shows an elevation as in FIG. 2 but after flying splice has taken place.

More specifically, FIG. 1 shows an adhesive tape 1 comprising a main carrier 2 of slightly crêped paper, coated on one side with a water-soluble self-adhesive composition 3. The total thickness of the main carrier 2 with self-adhesive composition 3 is 0.080 mm, the width 150 mm; it is commercialized as tesakrepp 51445 by Beiersdorf AG, Germany.

The self-adhesive composition 3 is lined with a siliconized release paper 4 provided at a distance of 75 mm from its left-hand edge with a slit 5, so that the left-hand portion 4a of the release paper 4 can be removed first of all, then the right-hand portion 4b. The left-hand portion 4a and the right-hand portion 4b are of the same size.

Bonded underneath in the central region of the adhesive tape 1 is a strip of a double-sided adhesive tape 6, composed of a carrier 7 made of splittable paper, coated on both sides with water-soluble self-adhesive composition 8 and 9 respectively. The adhesive tape has a width of 9 mm.

FIG. 2 illustrates how such an adhesive tape 1 is stuck beneath a paper web 11 of a reel of paper after portion 4a of the release paper 4 has been removed from the first part of said tape. Beforehand, the adhesive tape was bonded with the exposed self-adhesive composition 9 to the paper web 12 of the reel of paper, lying below the paper web 11. The right-hand portion 4b of the release paper 4 has also been removed, so that the reel of paper thus equipped is ready for a static manual reel changeover, with the bond of the adhesive tape 1 running at right angles over the reel.

The self-adhesive composition 3 is now exposed and constitutes the contact area with the paper web still to be bonded for the purpose of static manual changeover. The contact area has a width of 75 mm and extends over the entire width of the reel of paper.

The reel of paper thus equipped is brought into contact with the paper end of a further reel, the paper end is stuck onto the exposed adhesive, and the protruding part is torn off. Following joining, the reel of paper is accelerated, in an instant following acceleration the splittable paper carriers 7 split in such a way that one portion 7a remains on the adhesive tape 1, where it covers the self-adhesive composition 8, while the other portion 7b remains on the self-adhesive composition 9 which sticks to the paper web 12. Accordingly, both self-adhesive compositions 8 and 9 have been neutralized, so to speak, are no longer adhesive and hence do not disrupt the subsequent process in the paper processing machines.

The inventive adhesive tape provides for surprising simplification of the manual static reel changeover process. It is easier for a single person to apply over a web width of more than 5 m. There is no need for complicated assistants or mechanisms.

The application rate of the self-adhesive composition can be kept very low; unexpectedly from the standpoint of the skilled worker, even at application rates, for example, in the range between 20 and 60 g/m², particularly at 35 g/m² (within the framework of the customary error tolerances), the shear strength and bond strength of the self-adhesive composition are good and the adhesive tape is suitable for use for static manual reel changeover. As a result of the low application rates, the thickness of the adhesive tape is also low, with the consequence that the adhesive tape withstands the pressure stress within a wound reel outstandingly even for prolonged periods.

What is claimed is:

1. An adhesive tape for reel changeover of flat web material wound up into reels, comprising a main carrier, a self-adhesive composition on a face thereof, and at least one adhesive splittable system on the reverse, wherein the self-adhesive composition has a shear strength of at least 1000 minutes on coating basepaper and at least 2000 minutes on gravure paper, measured in each case at 23° C. and 55% relative humidity under a load of 1 kg.

2. The tape as claimed in claim 1, wherein any self-adhesive compositions are applied at a rate of from 15 to 60 g/m².

3. The tape as claimed in claim 2, wherein the self-adhesive compositions are applied at a rate of from 20-50 g/m².

4. The tape as claimed in claim 1, wherein the self-adhesive composition is based on acrylate.

5. The tape as claimed in claim 1, wherein the splittable system is composed of splittable paper.

6. The tape as claimed in claim 1, wherein the splittable system is based on a composite of sized highly compacted paper, on a composite of paper and film or on a composite of two films.

7. The tape as claimed in claim 1, wherein the splittable system has the same width as the main carrier.

8. The tape as claimed in claim 1, wherein the main carrier is a paper carrier or film carrier of high tensile strength.

9. The tape as claimed in claim 1, wherein the self-adhesive composition is provided with a covering which is provided where appropriate with a perforation or a slit in the lengthwise direction.

10. The tape as claimed in claim 1, wherein the splitting system exhibits a spliting resistance of from 5 to 70 cN/cm.

11. The tape as claimed in claim 10, wherein the splitting resistance is from 12 to 60 cN/cm.

12. The tape as claimed in claim 1, which is of symmetrical design with respect to a center plane in the lengthwise direction.

13. A method comprising using an adhesive tape, formed with a main carrier, a self-adhesive composition on a face thereof, and at least one adhesive splittable system on the reverse, to carry out a static manual reel changeover of flat web material wound up into reels, following application of a self-adhesive composition which has a shear strength of at least 1000 minutes on coating basepaper and at least 2000 minutes on gravure paper, measured in each case at 23° C. and 55% relative humidity under a load of 1 kg.
